(19) United States
(12) Patent Application Publication
(10) Pub. No.: US 2011/0203124 A1
(43) Pub. Date: Aug. 25, 2011

(54) Protective Covers for Wet Shaving Razors

(76) Inventors: Kelly Daniel Bridges, Abington, MA (US); Vincent Paul Walker, JR., Bridgewater, MA (US)

(21) Appl. No.: 12/708,769

(22) Filed: Feb. 19, 2010

(51) Int. Cl. B26B 21/40

(52) U.S. Cl. 30/539

(57) ABSTRACT

A shaving cartridge-cover assembly having a housing with a guard, a cap, a rear wall with at least one retention member, a front wall, and a pair of side walls. At least one blade is mounted to the housing between the guard and the cap. A protective cover has a top wall, a front wall and a rear wall that define a pair of opposing open ends. The housing has a dimension between the retention member and the front wall that is greater than an inner width of the open ends of the protective cover such that sliding one of the side walls of the housing into at least one of the open ends deflects the front and rear walls of the protective cover to facilitate mounting of the protective cover over the housing.

### FIELD OF THE INVENTION

The present invention relates to wet shaving blade assemblies, and more particularly, to wet shaving blade assemblies in which at least one blade is protected by a removable protective cover.

### BACKGROUND OF THE INVENTION

In general, a cartridge or blade unit of a safety razor has at least one blade with a cutting edge which is moved across the surface of the skin being shaved by means of a handle to which the cartridge is attached. The cartridge may be mounted detachably on the handle to enable the cartridge to be replaced by a fresh cartridge when the blade sharpness has diminished to an unsatisfactory level, or the cartridge may be attached permanently to the handle with the intention that the entire razor be discarded when the blade or blades have become dulled. Razor cartridges usually include a guard which contacts the skin in front of the blade(s) and a cap for contacting the skin behind the blade(s) during shaving. The cap and guard may aid in establishing the so-called “shaving geometry”, i.e., the parameters which determine the blade orientation and position relative to the skin during shaving, which in turn have a strong influence on the shaving performance and efficacy of the razor. The guard may be generally rigid, for example formed integrally with a frame or platform structure which provides a support for the blades.

Various types of protective covers, which are also known as overcaps, have been utilized with commercially available razors and razor cartridges. These covers may serve several purposes. First, the cover protects the razor cartridge and the blade edges during the different stages of shipping and retailing from forces which may damage the blade edges. Secondly, the cover also protects a user from unintentionally encountering the razor's sharp blade edge when the razor is not in use. Furthermore, the cover may serve as a storage unit for the razor cartridge between shaves. The covers which are currently available typically require a removal force in the direction of separation (i.e., the cover is either pulled or pushed directly off of the razor in the direction of the applied force). The removal of the cover may present issues for shaving razors that have a detachable cartridge because the user often unintentionally pulls the cartridge off of the handle because both the cartridge and the cover require the removal force in the same direction. The attachment mechanism of the shaving razor cartridge of handle may be damaged by the unintentional removal of the razor cartridge from the handle. In addition, the covers that are currently available require complex geometries to secure the overcap to the shaving razor cartridge. These complex geometries require the cover to be injection molded, which can increase capital costs, component costs, and manufacturing efficiency.

Many commercially available razor cartridges have a lubricating strip positioned on the cap, which is located behind the blades. The lubricating strip absorbs water and leaches out one or more lubrication aids during shaving to reduce the frictional drag of the blades against the skin. After shaving the user may store the cartridge in the cover. The lubricating strip may contact the cover, which may prevent proper drying of the lubricating strip or potentially damage the lubricating strip during subsequent removal. Furthermore, if the lubricating strip is not allowed to properly dry, it may continue to leach out water and shaving aid during storage. The water and shaving aid may leach onto the blades or the guard of the cartridge. The consumer may intuitively wipe the blade clean with a towel, but this may damage the edges of the blades. If water and shaving aid are allowed to dry on the blades, the blade edges may corrode faster and/or require extensive rinsing to remove the dried shaving aid prior to the next shave.

### SUMMARY OF THE INVENTION

In one aspect, the invention features, in general, a shaving cartridge-cover assembly having a housing with a guard, a cap, a rear wall with at least one retention member, a front wall, and a pair of side walls. At least one blade is mounted to the housing between the guard and the cap. A protective cover has a top wall, a front wall and a rear wall that define a pair of opposing open ends. The housing has a dimension between the retention member and the front wall that is greater than an inner width of the open ends of the protective cover such that sliding one of the side walls of the housing into at least one of the open ends deflects the front and rear walls of the protective cover to facilitate mounting of the protective over the housing.

In another aspect, the invention features, in general, a shaving cartridge-cover assembly with a housing having a rear wall, an opposing front wall, a guard, a cap, and a pair of spaced apart retention members on the rear wall of the housing. At least one blade is mounted to the housing between the guard and the cap. A protective cover is removably mounted to the housing. The protective cover has a uniform cross sectional profile defining a pair of opposing open ends each having an inner width. The protective cover has a first position and a second position. In the first position, the inner width of at least one of the open ends is less than a distance between at least one of the retention members and the front wall of the housing. In the second position, the inner width of at least one of the open ends is greater than a distance between at least one of the retention members and the front wall of the housing.

In yet another aspect, the invention features, in general, a shaving cartridge-cover assembly having a protective cover with a uniform cross sectional profile with a front wall, a rear wall, and a top wall interconnecting the front and rear walls. A housing is removably mounted to the protective cover. The housing has a rear wall, a front wall, a guard, a cap, and at least one blade between the guard and the cap. At least one of the front and rear walls of the housing has a pair of spaced apart retention members and the protective cover is mounted between the pair of retention members and covers at least a portion of the blade.

### BRIEF DESCRIPTION OF THE DRAWINGS

FIG. 1 is a perspective view of one possible embodiment of a shaving cartridge-cover assembly with a handle.

FIG. 2A is a perspective view of a shaving cartridge which may be incorporated into the shaving cartridge-cover assembly of FIG. 1.

FIG. 2B is a bottom view of the shaving cartridge of FIG. 2A.

FIG. 3 is side view of a protective cover which may be incorporated into the shaving cartridge-cover assembly of FIG. 1.

FIG. 4A is a rear view of the shaving cartridge-cover assembly of FIG. 1.

FIG. 4B is a side view of the shaving cartridge-cover assembly of FIG. 1.

FIG. 5 is a side view of another possible embodiment of a shaving cartridge which may be incorporated into the shaving cartridge-cover assembly of FIG. 1.

### DETAILED DESCRIPTION OF THE INVENTION

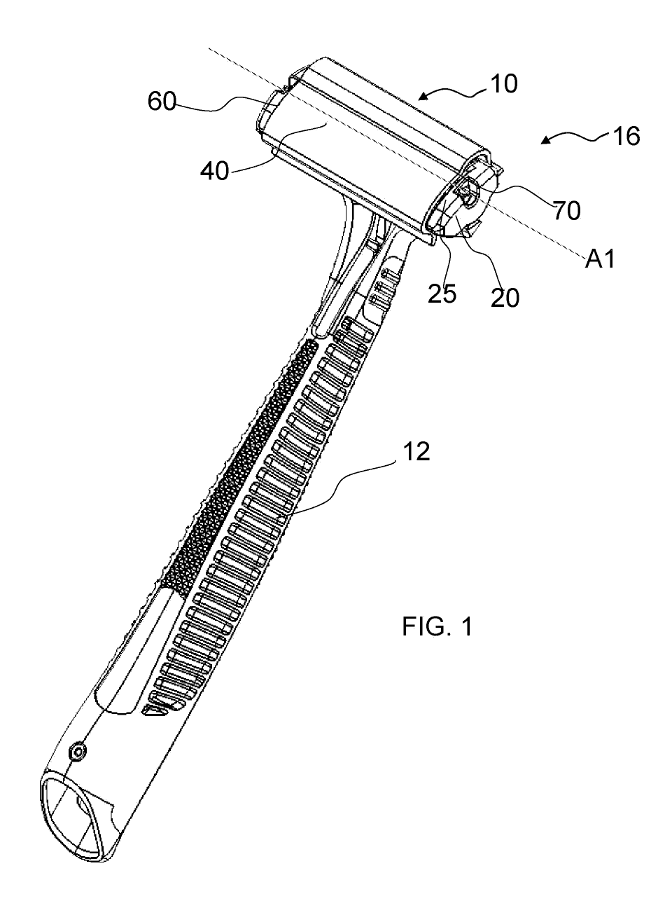

Referring to FIG. 1, one possible embodiment a shaving cartridge-cover assembly 10 mounted to a handle 12. The shaving cartridge-cover assembly 10 may include a shaving cartridge 20 and a removable protective cover 40. The shaving cartridge-cover assembly 10 may be sold by itself or as part of a shaving system 16 (i.e., the shaving cartridge 20, the removable protective cover 40, and the handle 12). The protective cover 40 may be mounted to the shaving cartridge 20 to protect the shaving cartridge 20 during different stages of shipping and retailing from forces which may damage the blade (hidden from view by the protective cover 40). The protective cover 40 may be mounted over a top face 25 of the shaving cartridge 20 to protect a user from unintentionally cutting themselves on an exposed sharp blade edge. The protective cover 40 may have a uniform cross sectional profile that defines a pair of opposing open ends 60 and 70 to facilitate mounting and removal of the protective cover 40 in a first direction. For example, the protective cover 40 may slide over the shaving cartridge 20 in a first direction along a longitudinal axis A1 of the shaving cartridge 20. The open ends 60 and 70 may also increase the flexibility of the protective cover 40 to facilitate snapping the protective cover 40 over the shaving cartridge 20 in a second direction that is transverse to the first direction (e.g., over the top face 25 of the shaving cartridge 20). The shaving cartridge 20 may be pivotably mounted to the handle 12 (i.e., rotation of the shaving cartridge 20 about an axis relative to the handle 12). The shaving cartridge 20 may detachably engaged to the handle 12 in a direction that is transverse to the attachment and removal of the protective cover 40. For example, the protective cover 40 may be removed from the shaving cartridge 20 along the axis A1 and the shaving cartridge 20 may detachably engaged to the handle 12 in a direction that is transverse the longitudinal axis A1. The shaving cartridge 20 may be attached permanently to the handle 12 with the intention that the entire assembly (i.e., the shaving cartridge 20 and handle 12) be discarded when the blade or blades have become dulled.

The protective cover 40 may be formed from a polymeric material using an extrusion process. Polymeric materials may include, but are not limited to polyolefins, such as polypropylene, polyethylene, and combinations thereof. The extrusion process is a method of producing near net shaped components of a uniform or constant cross-sectional profile to close tolerances in one operation. During the extrusion process, a solid polymeric material (also called a resin), usually in the form of beads or pellets, is continuously fed to a heated chamber and carried along by a feedscrew within. As the plastic material is conveyed it is compressed, melted, and forced out of the chamber at a steady rate through a die. The immediate cooling of the melt results in resolidification of the polymeric material into a continually drawn piece having a cross section matches the die profile. The extrusion process may be continuous (theoretically producing indefinitely long material) or semi-continuous (producing many pieces). Long pieces of extruded material may be cut to length at a later stage in the manufacturing process. Dies are engineered and machined to ensure that the melt flows in a precise desired shape, as well as, compensate for effects of shrinkage when a melt re-solidifies. A wide variety of materials may be extruded, including polymeric materials, metals, ceramics, concrete and paperboard.

One advantage of extrusion process over other manufacturing processes is the ability to create very complex cross-sections. Another advantage of extrusion is the ability to process materials that are brittle, because the material only encounters compressive and shear stresses during processing. Extrusion also forms finished parts with an excellent surface finish. Furthermore, there are financial benefits to be gained from using an extrusion compared to other methods of manufacture (e.g., injection molding). Complex extruded shapes that are close to the finished product profile can be produced in one operation, which enables very significant savings to be made on raw material usage and secondary operations. The material yield loss due to secondary machining or finishing operations can be greatly reduced or totally eliminated by using a near net extruded section. Higher value materials may also utilized because of the greater savings that result from the extrusion process. In addition, the tooling costs for an extrusion die (compared to injection molds) are low and the production change over down time between different sections is also comparatively short. Therefore, either long or short production runs are both practical and economical using the extrusion process.

The handle 12 and/or the shaving cartridge 20 may be injection molded from a semi-rigid polymeric material, for example, Noryl™ (a blend of polyphenylene oxide (PPO) and polystyrene developed by General Electric Plastics, now SABIC Innovative Plastics). The handle 12 and/or the shaving cartridge 20 may be molded from other semi-rigid polymeric materials having a Shore A hardness of about 50, 60, or 70 to about 90, 110, or 120, such as high impact polystyrene, polypropylene, acrylonitrile butadiene styrene, or any combination thereof. A semi-rigid polymeric material may allow the handle 12 and/or the shaving cartridge 20 to maintain a consistent geometry during shaving. The handle 12 and/or the shaving cartridge 20 may be of sufficient stiffness such that it does not bend or flex under normal shaving conditions, which may adversely influence the shave geometry of the shaving cartridge-cover assembly 10. In certain embodiments, the handle 12 and/or the shaving cartridge 20 may be manufactured from metals including, but not limited to aluminum or stainless steel.

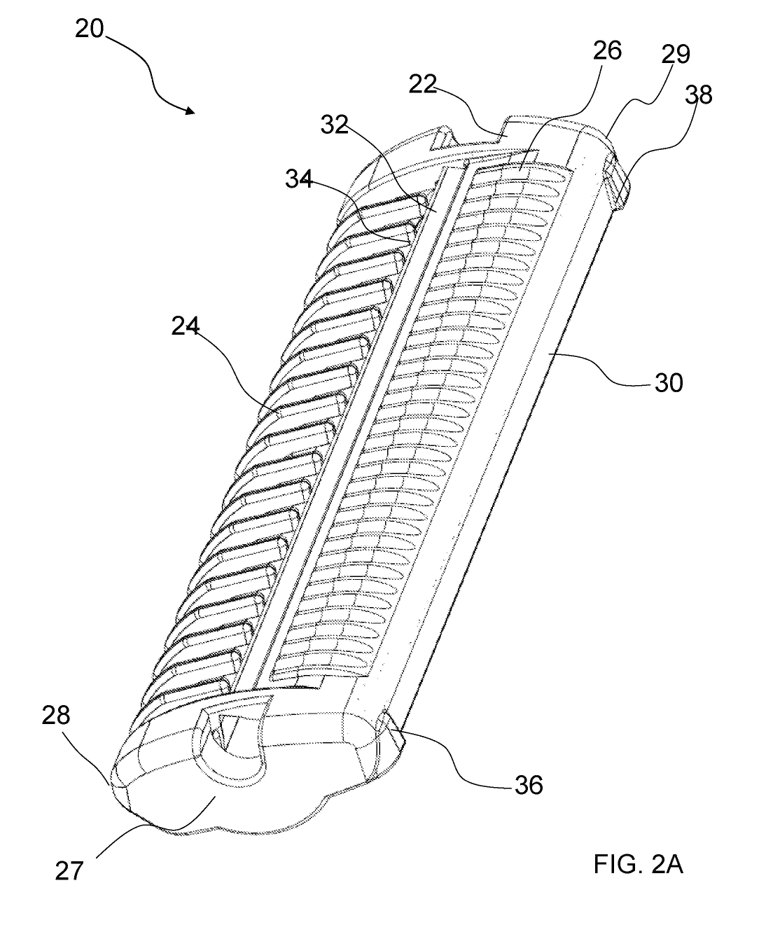

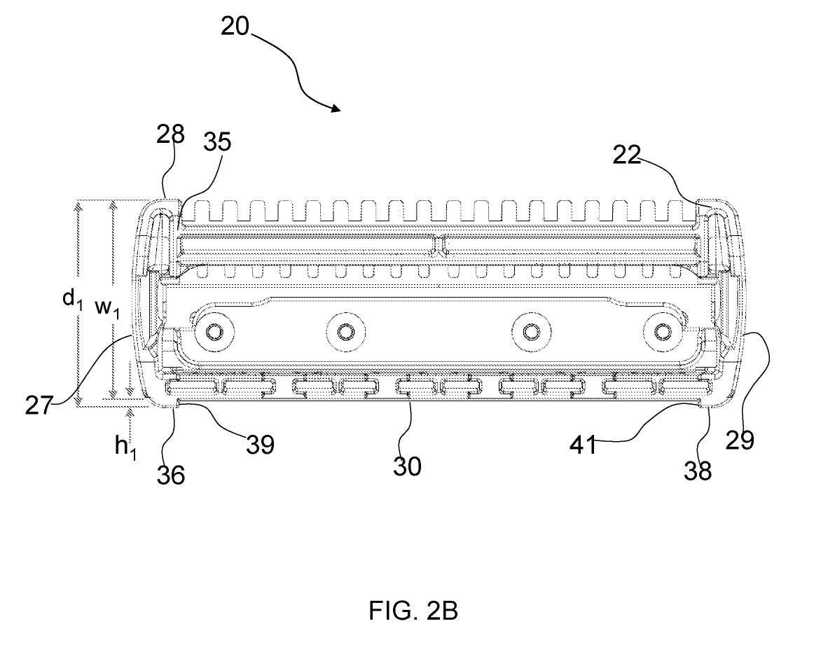

Referring to FIGS. 2A and 2B, a perspective view and a bottom view of the shaving cartridge 20 are shown (respectively). The shaving cartridge 20 may include a housing 22 having a guard 24 and a cap 26 positioned between a front wall 28 and a rear wall 30 of the housing 22. The housing 22 may also have a bottom face 35 on an opposite side of the guard 24 and the cap 26. The guard 24 may be positioned closest to the front wall 28 and the cap 26 may be positioned closest to the rear wall 30. The cap 26 may be molded or extruded from the same material as the housing 22 or may be molded or extruded from a more lubricious material that has a water-leachable shaving aid composition to provide increase comfort during shaving, such as a water-soluble polymer. Suitable skin lubricating water-soluble polymers may include polyethylene oxide, polyvinyl pyrrolidone, polyacrylamide, hydroxypropyl cellulose, polyvinyl imidazoline, and polyhydroxyethylmethacrylate. Other water-soluble polymers may include the polyethylene oxides generally known as POLYOX (available from Union Carbide Corporation) or ALKOX (available from Meisei Chemical Works, Kyota, Japan). These polyethylene oxides may have molecular weights of about 100,000 to 6 million, for example, about 300,000 to 5 million. The polyethylene oxide may comprises a blend of about 40 to 80% of polyethylene oxide having an average molecular weight of about 5 million (e.g., POLYOX COAGULANT) and about 60 to 20% of polyethylene oxide having an average molecular weight of about 300,000 (e.g., POLYOX WSR-N-750). The polyethylene oxide blend may also contain up to about 10% by weight of a low molecular weight (i.e., MW<10,000) polyethylene glycol such as PEG-100.

The cap 26 may also optionally include an inclusion complex of a skin-soothing agent with a cylcodextrin, low molecular weight water-soluble release enhancing agents such as polyethylene glycol (e.g., 1-10% by weight), water-swellable release enhancing agents such as cross-linked polyacrylics (e.g., 2-7% by weight), colorants, antioxidants, preservatives, microbicidal agents, beard softeners, astringents, depilatories, medicinal agents, conditioning agents, moisturizers, cooling agents, etc.

At least one blade 32 may be mounted to the housing 22 between the guard 24 and the cap 26. The blade 32 may have an exposed cutting edge 34 for cutting hair as the shaving cartridge 20 is moved across the surface of the skin. The blade 32 may be secured to the housing 22 using a cold staking process, but other assembly/securing methods known to those skilled in the art may be used including, but not limited to, wire wrapping, clips, hot staking, insert molding, and adhesives. Although only one blade 32 is shown, it is understood that the housing 22 may have more blades (e.g., two, three, four, five, or more). The guard 24 and the cap 26 may facilitate the protection of skin in a direction transverse to the blade 32 (e.g., minimizing nicks and cuts during shaving or handling of the shaving cartridge 20). However the guard 24 and the cap 26 may not protect against slicing (i.e., cutting in a direction parallel to the blade 32). As will be explained in greater detail below, the protective cover 40 may be mounted to the shaving cartridge 20 such that the blade 32 is not exposed (i.e., the protective cover 40 covers at least a portion of the blade 32).

The housing 22 may have a pair of opposing side walls 27 and 29 each having a width w₁ between the front wall 28 and the rear wall 30 of about 10 mm, 12 mm, or 14 mm to about 16 mm, 18 mm, or 20 mm. In certain embodiments, the rear wall 30 of the housing 22 may have a pair of spaced apart retention members 36 and 38 that minimize the unintentional removal of the protective cover 40 from the cartridge 20. The retention members 36 and 38 may include a raised surface such as a bump. The retention members 36 and 38 may also include a surface directly adjacent a recessed area. The retention members 36 and 38 may have a height h₁ measured outward from the rear wall 30 of about 0.15 mm, 0.25 mm, or 0.3 mm to about 0.35 mm, 0.4 mm, or 0.45 mm. The height h₁ may be increased or decreased to increase the force required to slide off the protective cover 40. At least one of the retention members 36 and 38 may have a straight inner wall 39 and 41 that is perpendicular to the rear wall 30 and the blade 32 (e.g., about 80 degrees, 84 degrees, or 88 degrees to about 90 degrees, 95 degrees, or 100 degrees). The straightness and/or angle of the inner walls 39 and 41 in relation to the rear wall 30 may increase the force required to remove the protective cover 40 without increasing the force required slide the protective cover 40 over the cartridge 20. A distance d₁ between at least one of the retention members 36 and 38 and the front wall 28 of the housing 22 may be greater than the width w₁ of the housing 22. For example, the distance d₁ may be about 12 mm, 14 mm, or 16 mm to about 24.5 mm, 26.5 mm, or 28.5 mm. It is understood that the dimensions for d₁ and w₁ may vary depending on the size of the cartridge 20 and/or housing 22. The protective cover 40 may expand to slide over the retention members 36 and 38 and then relax as the protective cover 40 is positioned between the pair of retention members 36 and 38. An audible sound, such as a click or a snap, may result as the protective cover 40 relaxes against the housing 22 to signal to the user that the protective cover 40 is properly mounted to the housing 22. The retention members 36 and 38 may allow the protective cover 40 to expand and slide over the cartridge 20, but prevent unintentional removal (e.g., sliding off) of the protective cover 40 from the cartridge 20.

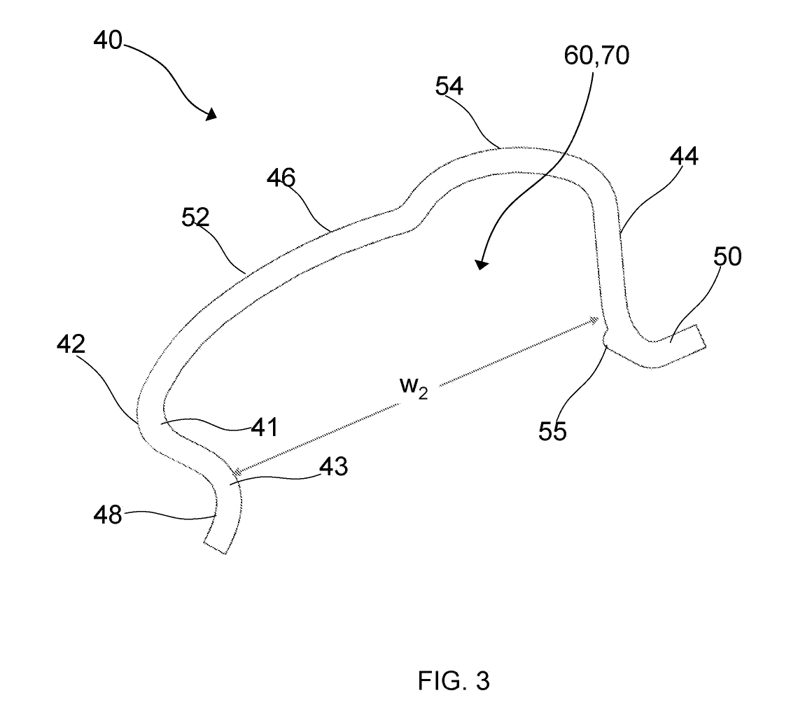

Referring to FIG. 3, a side view of the protective cover 40 is shown. The protective cover 40 may have a uniform cross sectional profile (e.g., the profile of the protective cover 40 is the same for its entire length) that defines a front wall 42, a rear wall 44, and a top wall 46 that interconnects the front wall 42 and the rear wall 44. The rear wall 44 may have an inner rib 55 to retain the cartridge within the protective cover 40. The rear wall 44 may be straight and the front wall 42 may have a concave inner surface portion 41 and a convex inner surface portion 43. The front wall 42 and/or the rear wall 44 may have a flange 48 and 50 (respectively) that extends away from the housing 22 and/or each other. One or more of the flanges 48 and 50 may act as a lever to facilitate the removal of the protective cover 40. One more of the flanges 48 and 50 may also facilitate the removal of the protective cover 40 in more than one direction by providing the user with area to grip the protective cover 40. For example, the user may grip and pull one or more of the flanges 48 and 50 away from the housing 22 to release the protective cover 40. Alternatively, the user may grip one or more of the flanges 48 and 50 to slide the protective cover off of the housing 22. The top wall 46 of the protective cover 40 may define a first radius 52 and a second radius 54. The first radius may be located toward the front wall 42 and the second radius may be located toward the rear wall 44. In certain embodiments, the second radius 54 may be less than the first radius 52. As will be described in greater detail below, second radius 54 may facilitate the spacing of the protective cover 40 away from the cap 26 of the housing 22.

The protective cover 40 may have a first position and a second position to facilitate the mounting and/or removal of the protective cover 40 from the cartridge 20. In the first position, at least one of the open ends 60 and 70 of the protective cover 40 may have an inner width w₂ from the rear wall 44 to the front wall 42 (e.g., convex inner surface portion 43). The inner width w₂ of at least one of the open ends 60 and 70 of the protective cover 40 in the first position may be less than d₁ (see FIG. 2B, the distance between at least one of the retention members 36 and 38 and the front wall 28 of the housing 22) to prevent the protective cover 40 from sliding off the housing 22. The rib 55 may support the housing 22 to aid in preventing the unintentional removal of the protective cover 40 from the housing 22. The protective cover 40 may be in the first position when the protective cover 40 is mounted between the retention members 36 and 38 of the housing 22 and/or the protective cover 40 is completely removed from the cartridge 20.

The dimension d₁ of the housing 22 (see FIG. 2B) may be greater than the inner width w₂ (in the first position) of at least one of the open ends 60 and 70 such that sliding one of the side walls 27 and 29 (see FIG. 2B) of the housing 22 into at least one of the open ends 60 and 70 deflects at least one of the front and rear walls 42 and 44 of the protective cover 40 to result in the second position. The second position may facilitate the mounting of the protective cover 40 to the housing 22 between the retention members 36 and 38 (see FIG. 2B). The protective cover 40 may be expanded to the second position as the protective cover is removed from or mounted to the cartridge 20. For example, in the expanded second position, the protective cover 40 may have an inner width w₂ that is greater than inner width w₂ of the protective cover 40 in the first position (non expanded) by about 2%, 4%, or 6% to about 8%, 10% or 12%. The inner width w₂ of the protective cover 40 in the second position may be greater than w₁ (distance between the front wall 28 and the rear wall 30 of the housing 22) to facilitate the mounting or removal of the protective cover 40 over the top face 25 of the cartridge 20 (transverse to the axis A1 shown in FIG. 1). The inner width w₂ of the protective cover 40 in the second position may also be greater than d₁ (distance between one of the retention members 36 and 38 and the front wall 28 of the housing 22) to facilitate the mounting or removal of the protective cover 40 from the cartridge 20 along the axis A1 (i.e., sliding). The mounting or removal of the protective cover 40 from the cartridge 20 along axis A1 may be in a direction that is transverse to the removal of the cartridge 20 from the handle 12 (see FIG. 1), which may prevent or minimize unintentional removal of the cartridge 20 from the handle 12.

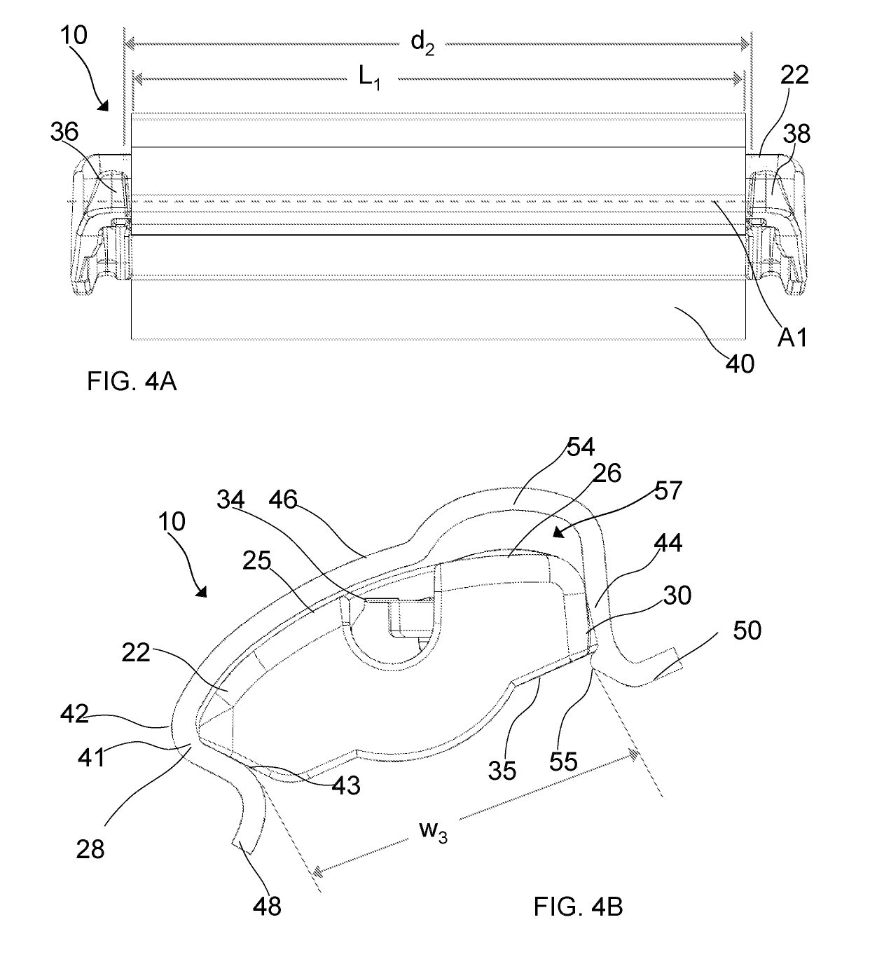

Referring to FIGS. 4A and 4B, a rear view and a cross section view of the shaving cartridge-cover assembly 10 is shown, respectively. The protective cover 40 may be mounted to the housing 22 such that a minimal portion of the blade edge 34 is exposed. The protective cover 40 may allow for attachment to the housing 22 by sliding and/or snapping over the top face 25 of the housing 22 (i.e., along axis A1 or transverse to axis A1). The dual functionality of the protective cover 40 allows the user to attach and/or remove the protective cover 40 with greater ease because the protective cover 40 can be mounted to or removed from the housing 22 in more than one direction. FIGS. 4A and 4B illustrate the protective cover 40 attached to the housing 22 in the first position. In the first position the protective cover 40 may be positioned between the pair of retention members 36 and 38. The protective cover 40 may slide freely between the pair of retention members 36 and 38 (i.e., the protective cover 40 has a length that is less than a distance d₂ between the pair of retention members 36 and 38). The retention members 36 and 38 may prevent the protective cover 40 from unintentionally sliding off of the housing 22 while allowing for greater tolerances in the overall length of the protective cover 40. The distance d₂ may be about 30 mm, 32 mm, or 34 mm to about 36 mm, 38 mm, or 40 mm. In certain embodiments, the protective cover 40 may have an overall length L₁ that is less than or equal to d₂. For example, overall length L₁ may be about 24 mm, 26 mm, or 28 mm to about 32 mm, 34 mm, or 36 mm.

As shown in FIG. 4B, the housing 22 may be positioned between the front wall 42 and the rear wall 44 of the protective cover 40. The front wall 42 of the protective cover 40 may contact the front wall 28 of the housing 22 and the rear wall 30 of the housing 22 may contact the rear wall 44 of the protective cover 40. In certain embodiments, the width w₁ of the housing 22 and the width w₂ of the protective cover 40 may be dimensioned such that the protective cover 40 applies a force against the housing 22, which may result in greater retention of the protective cover 40 on the housing 22. Alternatively, the width w₁ of the housing 22 and the width w₂ of the protective cover 40 may be dimensioned such the protective cover 40 applies little or no force to the housing 22. The housing 22 may also be supported and retained in a direction transverse to the axis A1 by the rib 55 and/or the convex inner surface portion 43 of the protective cover 40. The rib 55 and the convex inner surface portion 43 of the protective cover 40 may contact the bottom face 35 of the housing 22 to secure the housing 22 within the protective cover 40 and limit movement of the protective cover 40 in a direction transverse to A1. A distance w₃ between the rib 55 and the convex inner surface portion 43 of the protective cover 40 may be less than w₁ (see FIG. 2B) to limit movement of the protective cover 40 in a direction transverse to the axis A1. For example, w₃ be about 10 mm, 12 mm, or 14 mm to about 15 mm, 17 mm, or 19 mm.

In certain embodiments, the top wall 46 of the protective cover 40 may spaced apart (i.e., open space 57) from the cap 26 by about 0.5 mm, 0.75 mm, or 0.8 mm to about 1.0 mm, 1.5 mm, or 2.5 mm. The open space 57 and the open ends 60 and 70 (see FIG. 1) of the protective cover 40 may allow for drainage and ventilation of the housing 22 after shaving. The second radius 54 of the top wall 46 may allow the cap 26 to expand without contacting the protective cover 40 to prevent damage to the cap 26. The top wall 46 may not have any drainage openings, which may allow the protective cover 40 to be extruded. The dimensions of the open space 57 alone or in combination with the open ends 60 and 70 may allow for adequate drainage and ventilation despite a lack of openings in the top wall 46. Alternatively, a secondary operation may be used to create drainage openings in the top wall 46 for additional drainage and ventilation.

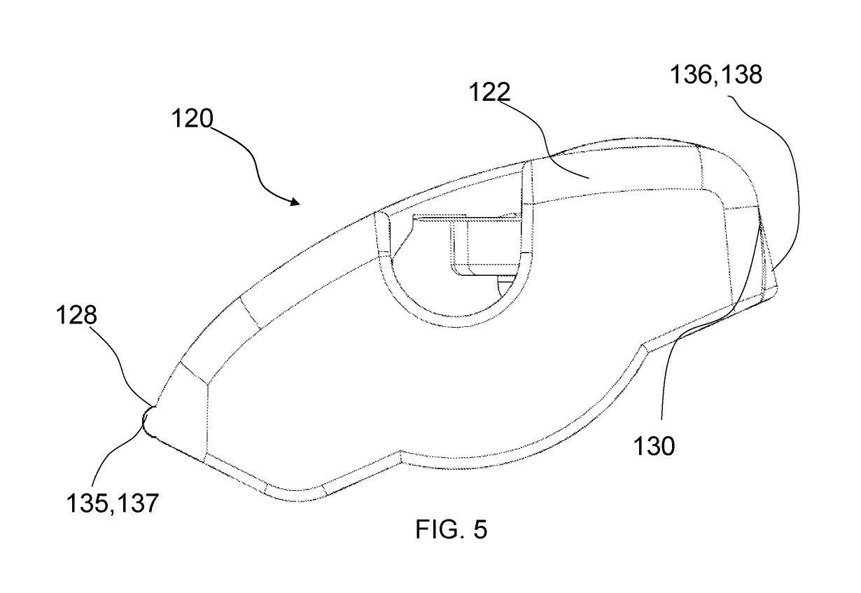

Referring to FIG. 5, a side view of another possible embodiment of a shaving cartridge 120 is shown. The shaving cartridge 120 may be the same as the shaving cartridge 20 described above, except that the shaving cartridge 120 may have a housing 122 with a pair of spaced apart retention members 135 and 137 located at or on a front wall 128 of the housing. The retention members 135 and 137 at the front wall 128 of the housing 122 may be in addition to a pair of retention members 136 and 138 at or on a rear wall of the housing 122. The protective cover 40 may be mounted to the housing 122 in the same manner as the housing 22 described above. The two pairs of retention members 135 and 137 and 136 and 138 may increase the force required to slide the protective cover 40 off of the housing 122 compared to only one pair of retention members. In certain embodiments, the housing 122 may have the retention members 135 and 137 at the front wall 128 of the housing 122 and no retention members 136 and 138 at the rear wall 130.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A shaving cartridge-cover assembly comprising:
a housing having a guard, a cap, a rear wall with at least one retention member, a front wall, and a pair of side walls;
at least one blade mounted to the housing between the guard and the cap; and
a protective cover having a top wall, a front wall and a rear wall that define a pair of opposing open ends, the housing having a dimension between the retention member and the front wall that is greater than an inner width of the open ends wherein sliding one of the side walls of the housing into at least one of the open ends deflects the front and rear walls of the protective cover to facilitate mounting of the protective cover over the housing.

2. The shaving cartridge-cover assembly of claim 1 wherein the protective cover is detachably mountable to the housing in a first direction along a longitudinal axis of the housing and in a second direction transverse to the longitudinal axis of the housing.

3. The shaving cartridge-cover assembly of claim 1 wherein at least one of the front and rear walls of the protective cover has a flange extending away from the housing.

4. The shaving cartridge-cover assembly of claim 1 wherein the rear wall has a pair of spaced apart retention members and the protective cover is mounted between the pair retention members.

5. The shaving cartridge-cover assembly of claim 1 wherein the front and rear walls of the protective cover each has a flange extending away from the housing.

6. The shaving cartridge-cover assembly of claim 1 wherein protective cover has a uniform cross sectional profile.

7. The shaving cartridge-cover assembly of claim 6 wherein the top wall of the protective cover is spaced apart from the cap.

8. The shaving cartridge-cover assembly of claim 6 wherein the rear wall of the protective cover has an inner surface with a rib extending from one of the opposing ends to the other opposing end.

9. A shaving cartridge-cover assembly comprising:
a housing having a rear wall, an opposing front wall, a guard, a cap, and a pair of spaced apart retention members on the rear wall of the housing;
at least one blade mounted to the housing between the guard and the cap
a protective cover removably mounted to the housing, the protective cover having a uniform cross sectional profile defining a pair of opposing open ends each having an inner width, the protective cover having a first position and a second position, wherein in the first position the inner width of at least one of the open ends is less than a distance between at least one of the retention members and the front wall of the housing and in the second position the inner width of at least one of the open ends is greater than a distance between at least one of the retention members and the front wall of the housing.

10. The shaving cartridge-cover assembly of claim 9 wherein the protective cover is mounted between the pair of retention members in the first position.

11. The shaving cartridge-cover assembly of claim 9 wherein the protective cover is detachably mountable to the housing in a first direction along a longitudinal axis of the housing and in a second direction transverse to the longitudinal axis of the housing.

12. The shaving cartridge-cover assembly of claim 9 wherein at least one of the front and rear walls of the protective cover has a flange that extends away from the housing.

13. The shaving cartridge-cover assembly of claim 9 wherein the front and rear walls of the protective cover each has a flange extending away from the housing.

14. The shaving cartridge-cover assembly of claim 9 wherein the top wall of the protective cover is spaced apart from the cap.

15. The shaving cartridge-cover assembly of claim 9 wherein the rear wall of the protective cover has an inner surface with a rib extending from one of the opposing ends to the other opposing end.

16. A shaving cartridge-cover assembly comprising:
a protective cover with a uniform cross sectional profile having a front wall, a rear wall, and a top wall interconnecting the front and rear walls,
a housing removably mounted to the protective cover, the housing having a rear wall, a front wall, a guard, a cap, and at least one blade between the guard and the cap, wherein at least one of the front and rear walls of the housing has a pair of spaced apart retention members and the protective cover is mounted between the pair of retention members to cover at least a portion of the blade.

17. The shaving cartridge-cover assembly of claim 16 wherein the front wall has a convex and concave inner surfaces.

18. The shaving cartridge-cover assembly of claim 17 wherein the front and rear walls each have a flange.

19. The shaving cartridge-cover assembly of claim 17 wherein the flanges extend away from each other.

20. The shaving cartridge-cover assembly of claim 19 wherein the front wall of the housing contacts the concave inner surface of the protective cover and the rear wall of the housing contacts the rear wall of the protective cover.
